(19) United States
(12) Patent Application Publication
(10) Pub. No.: US 2025/0072322 A1
(43) Pub. Date: Mar. 6, 2025

(54) MANNED MOWER

(71) Applicant: Nanjing Chervon Industry Co., Ltd., Nanjing (CN)

(72) Inventors: Fan Gao, Nanjing (CN); Lele Liu, Nanjing (CN)

(21) Appl. No.: 18/755,340

(22) Filed: Jun. 26, 2024

(30) Foreign Application Priority Data
Aug. 30, 2023 (CN) 202311111501.2
Aug. 30, 2023 (CN) 202322353806.6
Aug. 30, 2023 (CN) 202322355975.3

(51) Int. Cl. A01D 34/78; A01D 34/64; A01D 34/81; A01D 34/82; A01D 101/00

(52) U.S. Cl. CPC A01D 34/78; A01D 34/64; A01D 34/81; A01D 34/82; A01D 2101/00

(57) ABSTRACT

A manned mower includes a seat; a frame for supporting the seat; a cutting assembly mounted on the frame and including a mowing element for cutting grass; a walking assembly mounted on the frame and including a left walking wheel and a right walking wheel; an energy storage device disposed on the front side of the seat and configured to supply power to the cutting assembly and the walking assembly; and a front cover disposed on a front portion of the manned mower and formed with an accommodation cavity for accommodating at least the energy storage device. In a front and rear direction, the center of gravity of the energy storage device is located before a line between the center point of the left walking wheel and the center point of the right walking wheel.

### RELATED APPLICATION INFORMATION

This application claims the benefit under 35 U.S.C. § 119 (a) of Chinese Patent Application No. 202311111501.2, filed on Aug. 30, 2023, Chinese Patent Application No. 202322353806.6, filed on Aug. 30, 2023, and Chinese Patent Application No. 202322355975.3, filed on Aug. 30, 2023, which applications are incorporated herein by reference in their entireties.

### TECHNICAL FIELD

The present application relates to a garden tool and, in particular, to a manned mower.

### BACKGROUND

As a garden tool, a manned mowing apparatus in the related art is widely used for trimming lawns, vegetation, etc. A mowing tractor saves more labor and has higher mowing efficiency than a push mower. Mowing tractors on the market usually use diesel as the energy supply, which causes a lot of noise and environmental pollution and requires the frequent replacement of quick-wear parts in a fuel system, resulting in an increase in the maintenance costs. Due to a relatively large volume of a fuel engine, most space in the front of the mowing tractor is used for arranging the fuel system.

This part provides background information related to the present application, which is not necessarily the existing art.

### SUMMARY

In an example, a manned mower includes a seat; a frame for supporting the seat; a cutting assembly mounted on the frame and including a mowing element for cutting grass; a walking assembly mounted on the frame and including a front walking assembly, where the front walking assembly includes a left walking wheel and a right walking wheel; an energy storage device disposed on the front side of the seat and configured to supply power to the cutting assembly and the walking assembly; and a front cover disposed on a front portion of the manned mower and formed with an accommodation cavity for accommodating at least the energy storage device. In a front and rear direction, the center of gravity of the energy storage device is located before a line between the center point of the left walking wheel and the center point of the right walking wheel.

In some examples, the energy storage device is undetachably mounted on the manned mower.

In some examples, the energy storage device includes at least one battery pack, where the at least one battery pack includes lithium iron phosphate cells.

In some examples, total energy of the at least one battery pack is greater than or equal to 2 kW·h.

In some examples, in an up and down direction, the distance H between the center of gravity of the energy storage device and a walking plane is greater than or equal to 380 mm and less than or equal to 520 mm.

In some examples, in the front and rear direction, the distance L2 between the center of gravity of the energy storage device and the line is greater than or equal to 0 mm and less than or equal to 200 mm.

In some examples, in the front and rear direction, the energy storage device is disposed on the front side of the seat and in a front portion of the accommodation cavity.

In some examples, the energy storage device further includes a battery management circuit board disposed in the accommodation cavity and above the at least one battery pack.

In some examples, a storage member is further included, where at least part of the storage member is movably connected to the front cover.

In some examples, the storage member is formed with a storage space opened upward, and the storage space is located behind the energy storage device in the front and rear direction; and the front cover includes an upper lid, the upper lid has an opened position and a closed position, and when the upper lid is at the opened position, the storage space is touchable by a user.

In some examples, the storage space is separated from the energy storage device by the storage member.

### BRIEF DESCRIPTION OF DRAWINGS

FIG. 1 is a perspective view of a manned mower according to an example of the present application;

FIG. 2 is an electrical schematic of the manned mower of FIG. 1;

FIG. 3 is a perspective view of a walking assembly, a frame, and a housing system of the manned mower of FIG. 1;

FIG. 4 is a perspective view of a storage member in a flipped state according to an example of the present application;

FIG. 5 a schematic view of a storage member according to another example of the present application;

FIG. 6 is a schematic view of the structure shown in FIG. 5 when a first storage member is taken out;

FIG. 7 is a schematic view of a first storage member, a second storage member, and a front cover in FIG. 5;

FIG. 8 is a perspective view of an energy storage device according to an example of the present application;

FIG. 9 is a perspective view of a tool attachment device according to an example of the present application; and

FIG. 10 is a perspective view of a tool attachment device according to another example of the present application.

### DETAILED DESCRIPTION

Before any example of the present application is explained in detail, it is to be understood that the present application is not limited to the application in the structural details and arrangement of components set forth in the following description or shown in the preceding drawings.

In the present application, the term “comprising”, “including”, “having”, or any other variant thereof is intended to encompass a non-exclusive inclusion so that a process, method, article, or apparatus that includes a series of elements not only includes those elements but also includes other elements that are not expressly listed or further includes elements that are inherent to such a process, method, article, or apparatus. In the absence of more limitations, an element defined by the statement “including a . . . ” does not exclude the presence of additional identical elements in a process, method, article, or device including the element.

In the present application, the term “and/or” is an association relationship describing associated objects and indicates that three relationships may exist. For example, A and/or B may indicate that A exists alone, both A and B exist, and B exists alone. In addition, in the present application, the character “/” generally indicates an “and/or” relationship between associated objects before and after the character “/”.

In the present application, the term “connected”, “combined”, “coupled”, or “mounted” may be directly “connected”, “combined”, “coupled”, or “mounted” and may also be indirectly “connected”, “combined”, “coupled”, or “mounted”. For example, the direct connection indicates that two parts or assemblies are connected together without an intermediate piece, and the indirect connection indicates that two parts or assemblies are separately connected to at least one intermediate piece and the two parts or assemblies are connected through the intermediate piece. Furthermore, “connected” and “coupled” are not limited to physical or mechanical connections or couplings and may include electrical connections or couplings.

In the present application, it is to be understood by those of ordinary skill in the art that a relative term (for example, “about”, “approximately”, or “basically”) used in conjunction with quantities or conditions is inclusive of the stated value and has the meaning indicated by the context. For example, the relative term includes at least the degree of error associated with the measurement of a particular value, the tolerance resulting from manufacturing, assembly, and usage and associated with a particular value, and the like. Such a term is to be construed as disclosing a range defined by the absolute values of two endpoints. The relative term may refer to plus or minus a certain percentage (such as 1%, 5%, 10%, or more) of an indicated value. A value not modified by the relative term should also be disclosed as a particular value with a tolerance. In addition, when expressing a relative angular position relationship (for example, basically parallel or basically perpendicular), “basically” may refer to plus or minus a certain degree (such as 1 degree, 5 degrees, 10 degrees, or more) based on an indicated angle.

In the present application, it is to be understood by those of ordinary skill in the art that the function implemented by an assembly may be implemented by one assembly, multiple assemblies, one part, or multiple parts. Similarly, the function implemented by a part may be implemented by one part, one assembly, or a combination of multiple parts.

In the present application, the terms “upper”, “lower”, “left”, “right”, “front”, “rear”, and other orientation words are described by the orientations and position relations shown in the drawings and should not be understood as a limitation to the examples of the present application. In addition, in the context, it is to be understood that when an element is connected “above” or “below” another element, the element not only can be directly connected “above” or “below” another element but also can be indirectly connected “above” or “below” another element through an intermediate element. It is also to be understood that orientation words such as an upper side, a lower side, a left side, a right side, a front side, and a rear side not only represent positive orientations but also may be understood as lateral orientations. For example, the term “below” may refer to “directly below”, “on a lower left”, “on a lower right”, “on a front lower side”, “on a rear lower side”, and the like.

In the present application, the terms “controller”, “processor”, “central processing unit”, “central processing unit (CPU)”, and “microcontroller unit (MCU)” are interchangeable. Where a unit such as the “controller”, the “processor”, the “central processing unit”, the “CPU”, or the “MCU” is used to implement specific functions, these functions may be implemented by a single one of the preceding units or multiple preceding units unless otherwise indicated.

In the present application, the term “device”, “module”, or “unit” is used to implement a specific function in the form of hardware or software.

In the present application, the terms “computing”, “judging”, “controlling”, “determining”, “identifying”, and the like refer to the operations and processes of a computer system or similar electronic computing device (for example, the controller, the processor, or the like).

The present application is described below in detail in conjunction with the drawings and examples.

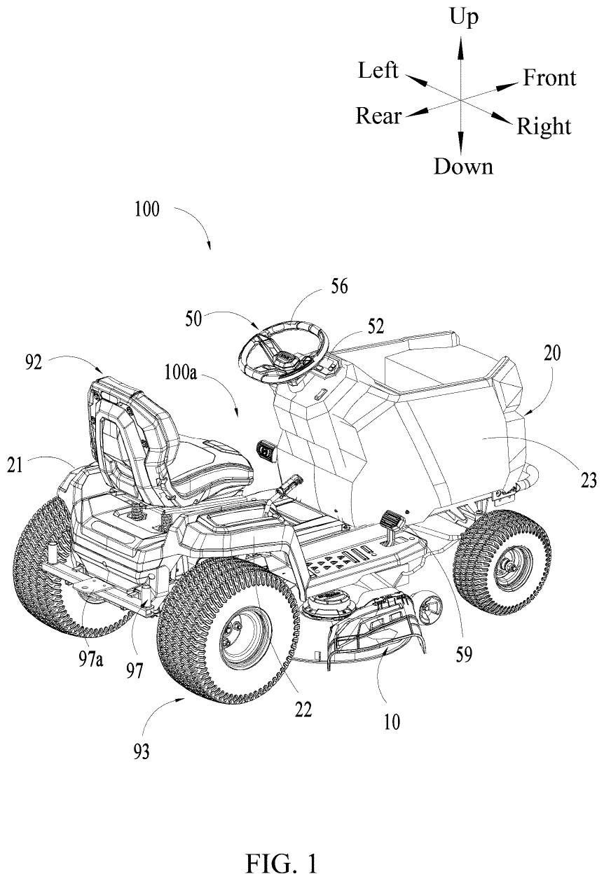

FIG. 1 shows a manned mower 100 according to an example of the present application, and the manned mower 100 is specifically a mowing tractor. The manned mower 100 may be used for a user to sit or stand on and operate to trim lawns and vegetation. In this specification, front, rear, left, right, up, and down are described as directions shown in FIG. 1. Specifically, when the user is carried on the manned mower 100 located on the ground, a direction that the user faces is defined as the front, a direction on the back of the user is defined as the rear, a direction on a left-hand side of the user is defined as the left, a direction on a right-hand side of the user is defined as the right, a direction towards the ground is defined as down, and a direction away from the ground is defined as up.

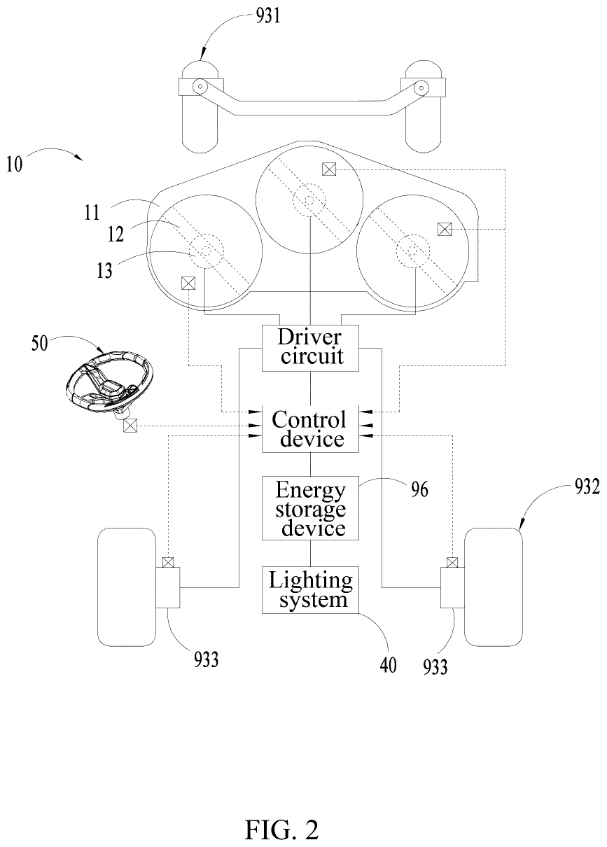

As shown in FIGS. 1 to 3, the manned mower 100 includes a cutting assembly 10, a frame 91, a seat 92, a housing system 20, a walking assembly 93, an energy storage device 96, a lighting system 40, and an operating assembly 50. The frame 91 and the housing system 20 constitute a main machine 100a of the manned mower 100, the main machine 100a is used for mounting the cutting assembly 10, the seat 92, the energy storage device 96, and the lighting system 40, and the walking assembly 93 is used for supporting the main machine 100a. The manned mower 100 provides energy for the cutting assembly 10, the walking assembly 93, the lighting system 40, and the like through a power assembly. In this example, the power assembly of the manned mower 100 is the energy storage device 96 which provides electrical energy for each assembly of the manned mower 100 so that the manned mower 100 can be used as a power tool. The electric manned mower 100 is more environmentally friendly and more energy-efficient than a fuel-based manned mower 100.

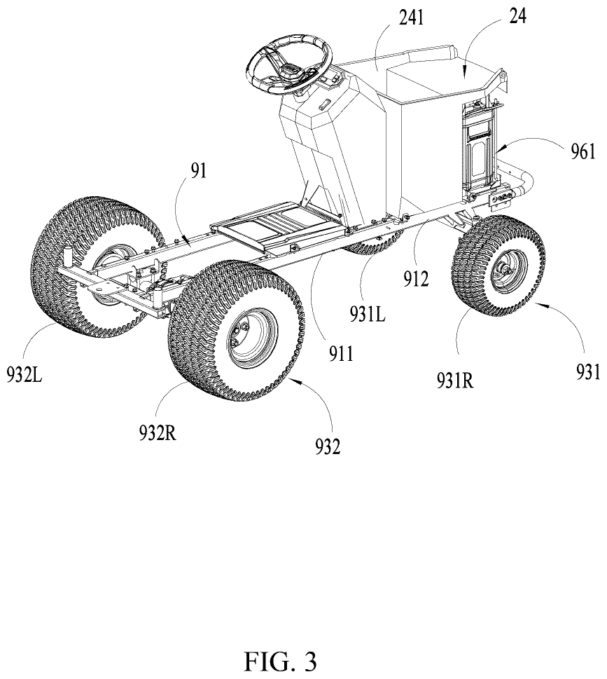

The cutting assembly 10 is configured to output power to implement the function of the manned mower 100. The cutting assembly 10 serves as a power output member, and the main machine 100a supports the power output member. The cutting assembly 10 includes a cutting disk 11, a mowing element 12, and a first motor 13. The mowing element 12 is configured to cut the vegetation when rotating at a high speed. For example, the mowing element 12 is a blade for cutting grass on a lawn. The cutting disk 11 surrounds a mowing space 121 for accommodating at least part of the mowing element 12, that is to say, the mowing element 12 is at least partially accommodated in the cutting disk 11. The first motor 13 is configured to drive the mowing element 12 to rotate. As shown in FIG. 3, the cutting assembly 10 is disposed below the frame 91. In some examples, two mowing elements 12 may be provided, two first motors 13 may be provided, and correspondingly, the two first motors 13 drive the two mowing elements 12 one to one. In some examples, three mowing elements 12 may be provided, three first motors 13 may be provided, and correspondingly, the three first motors 13 drive the three mowing elements 12 one to one. The mowing element 12 is disposed in the mowing space 121 surrounded by the cutting disk 11. The mowing space 121 is open downward so that the mowing element 12 can cut the vegetation below the mowing space 121. In some examples, the manned mower 100 may further include a grass collection system, that is, the user may selectively mount the grass collection system, and the grass collection system is used for collecting grass clippings after the cutting of the cutting assembly 10. In some examples, the grass collection system includes a grass collection basket assembly detachably mounted behind the seat 92. The seat 92 includes a seat cushion and a backrest. The seat cushion is used for the user to sit on, and the backrest is used for supporting the back of the user. Therefore, in other words, the grass collection basket assembly is mounted behind the backrest.

In some examples, the cutting assembly 10 may be detached from the manned mower 100. In this case, other work attachments may be connected to the manned mower 100, such as a snow shoveling assembly. The snow shoveling assembly includes a snow shovel and a snow shovel angle adjustment device, and the snow shoveling assembly may be hung on the frame 91. In this case, strictly speaking, the manned mower 100 is no longer just a manned mowing apparatus but a manned machine which can complete different work according to different work attachments connected. The manned mower 100 has at least one work attachment interface, such as a hook, a thread, a hole, or a groove. Due to a strong load-bearing capacity of the frame 91, the at least one work attachment interface may be formed on or fixed to the frame 91. Different work attachment interfaces are used for matching different work attachments, and the same work attachment interface may match different work attachments.

The frame 91 extends basically along a front and rear direction. The cutting assembly 10, the housing system 20, the walking assembly 93, the energy storage device 96, the grass collection system, and the lighting system 40 are all mounted to the frame 91. The frame 91 is used for supporting the main machine 100a of the entire manned mower 100. The walking assembly 93 is used for supporting the frame 91 so that the manned mower 100 can walk on the ground. The walking assembly 93 includes a first walking assembly 931, a second walking assembly 932, and a second motor 933 for driving the first walking assembly 931 or the second walking assembly 932. In this example, the first walking assembly 931 is a front walking assembly and includes two first walking wheels (front wheels), that is, a first left walking wheel 931L and a first right walking wheel 931R. The second walking assembly 932 is a rear walking assembly and includes two second walking wheels (rear wheels), that is, a second left walking wheel 932L and a second right walking wheel 932R. The radius of the second walking wheels is greater than the radius of the first walking wheels.

The frame 91 includes longitudinal beams and cross beams. In some examples, the frame 91 includes two longitudinal beams which are a first longitudinal beam 911 and a second longitudinal beam 912, respectively. In some examples, the frame 91 further includes two cross beams, which are a first cross beam and a second cross beam, respectively. Specifically, the first longitudinal beam 911 is disposed on the left side of the seat 92 and the second longitudinal beam 912 is disposed on the right side of the seat 92. The first cross beam 913 is basically located at the front end of the manned mower 100 and the second cross beam 914 is basically located at the rear end of the manned mower 100. In this example, the height of the frame 91 is relatively low, thereby lowering the center of gravity of the entire manned mower 100 and enabling the manned mower 100 to travel smoothly.

The lighting system 40 includes a front lighting assembly, a left lighting assembly, and a right lighting assembly. In some examples, the lighting system 40 further includes a rear lighting assembly. The front lighting assembly is disposed on the front side of the seat 92, the left lighting assembly is disposed on the left side of the seat 92, the right lighting assembly is disposed on the right side of the seat 92, and the rear lighting assembly is disposed on the rear side of the seat 92. In this manner, the front lighting assembly can illuminate an area in front of the manned mower 100, and the left lighting assembly and the right lighting assembly may serve as position lights of the manned mower 100, thereby making it convenient for other persons around the manned mower 100 to observe the outline of the manned mower 100.

The housing system 20 includes a left cover 21, a right cover 22, and a front cover 23. The front cover 23 is disposed on a front portion of the manned mower 100 and is the front face of the manned mower 100. The left cover 21 is disposed on the left side of the seat 92 and the right cover 22 is disposed on the right side of the seat 92. In some examples, the left cover 21 at least partially covers the second left walking wheel 932L and the right cover 22 at least partially covers the second right walking wheel 932R. The left cover 21 and the right cover 22 may be two separately formed components, or the left cover 21 and the right cover 22 may be one integrally formed component, that is, the left cover 21 and the right cover 22 are connected into a whole to form one cover, where the one cover at least partially covers the second walking assembly 932 as a whole. Specific structures and materials of the left cover 21 and the right cover 22 are not limited in the present application.

As shown in FIG. 1, the front portion of the manned mower 100 can accommodate the energy storage device 96, and besides, an accommodation cavity covered by the front cover 23 still has space for implementing a storage function. In some examples, the front cover 23 may be a metal member, which can not only facilitate the heat dissipation of the energy storage device 96 but also increase the strength of a front housing. Of course, the front cover 23 may be made of plastic, thereby saving costs. The specific structure and material of the front cover 23 are not limited in the present application.

In some examples, the housing system 20 of the manned mower 100 further includes a storage member 24, where at least part of the storage member 24 is movably connected to the front cover 23. The storage member 24 is formed with at least one storage space 241 opened basically upward, and the storage space 241 is located behind the energy storage device 96 in the front and rear direction. It is to be noted that the storage space 241 and the accommodation cavity formed for accommodating the energy storage device by the front cover are not the same space. Storage boxes of related mowers are all fixedly mounted to the vehicle body, which greatly reduces the flexibility of use by the user and is not conducive to cleaning the internal space. In the present application, the storage member 24 is movably connected to the front cover 23, making it easier for the user to take articles out of the storage space. For example, when the user stores chemical fertilizer or crops in the storage space 241, the user may adjust the angle of the storage member 24 or directly take out the storage member 24 so that the chemical fertilizer or crops can be more conveniently taken out. When the storage member is in a storage state, the storage member can form an accommodation cavity with the front cover, and the accommodation cavity is used for accommodating the energy storage device. Of course, one accommodation cavity may be independently disposed in the front cover for the energy storage device.

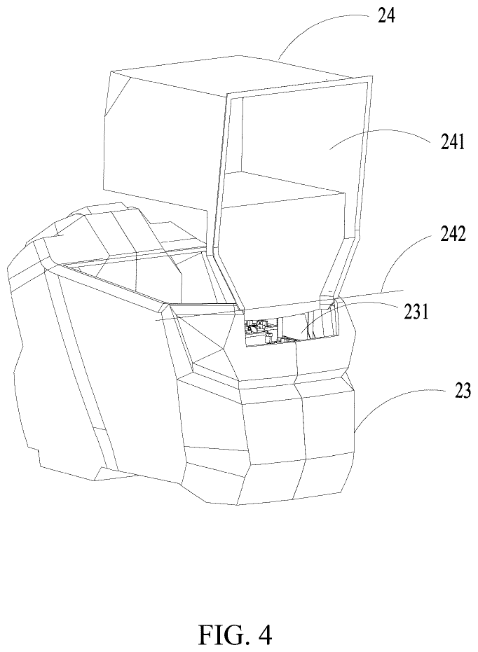

In some examples, as shown in FIG. 4, the storage member 24 is a flip storage box, and an end of the storage member 24 is rotatably mounted to the front cover 23. The storage member 24 can be flipped relative to the front cover 23 so that an opening direction of the storage space 241 is changed. Specifically, the storage member 24 further includes a spindle. The spindle is connected to the front cover 23, and the storage member 24 may turn around an axis 242 of the spindle within a preset angle range. An angle the storage member 24 turns around the axis 242 is less than or equal to 180°. Of course, the spindle may be connected to the storage member 24, and the preceding angle is to be understood as an angle the storage member 24 turns relative to the front cover 23.

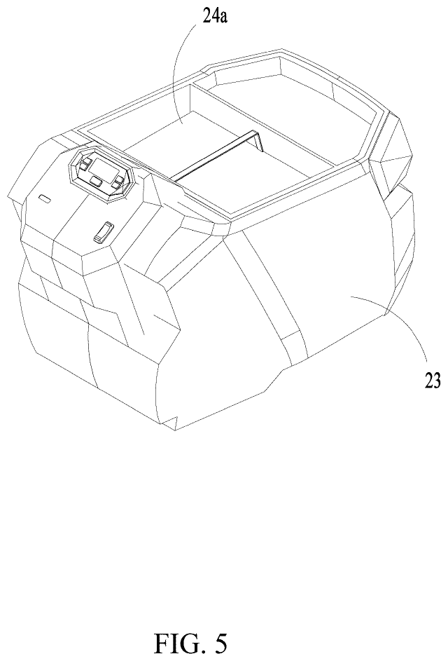

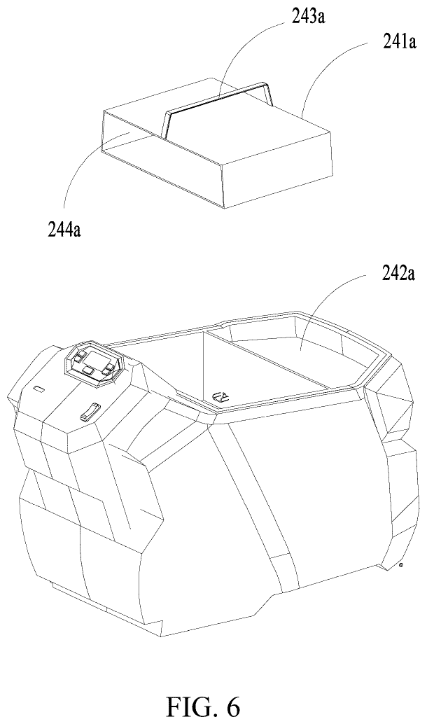

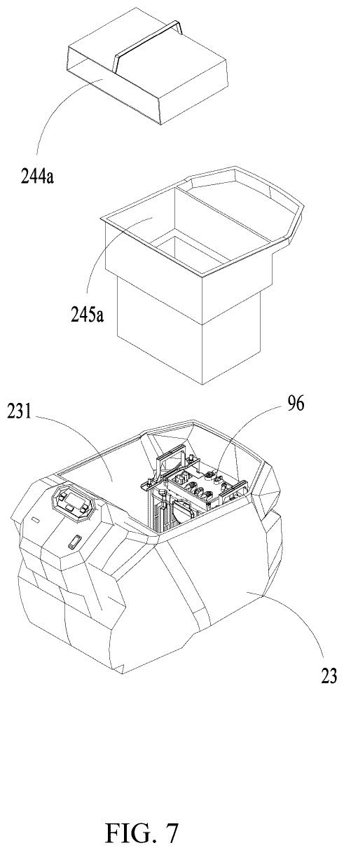

In some other examples, as shown in FIGS. 5 to 7, the front cover 23 is formed with an accommodation cavity 231 for accommodating at least the energy storage device 96. At least part of a storage member 24a is disposed behind the energy storage device 96. A difference from the preceding example is that the storage member 24a is a pull-out storage box, and at least part of the storage member 24a can move relative to the front cover 23. Specifically, the storage member 24a includes a first storage member 241a and a second storage member 242a. The first storage member 241a can be separated from the front cover 23. The second storage member 242a is connected to the front cover 23 in a fixed or flippable manner. The first storage member 241a has a handle 243a convenient for the user to operate. The user can conveniently pull the handle 243a to take or place the first storage member 241a freely. Of course, the handle 243a may be foldable so that space can be saved. In some examples, the handle 243a is not a real handle, and any position of the first storage member 241a grippable by the user may be considered as the handle. Therefore, the form and position of the handle 243a are not limited in the present application. The first storage member 241a forms a first storage space 244a and the second storage member 242a forms a second storage space 245a. An opening direction of the first storage space 244a is different from an opening direction of the second storage space 245a. The volume of the first storage space 244a is different from the volume of the second storage space 245a. After pulling out the first storage member 241a, the user may take an article from or store an article into the second storage space 245a. In this manner, the user can store different articles separately, improving user experience.

The front cover 23 includes an upper lid having an opened position and a closed position. When the upper lid is at the opened position, the user may touch the storage space 241, flip the storage member 24, or take articles from the storage member 24. The storage space 241 may be used for storing small tools, gloves, sun protection hats, and even clothes according to requirements of the user, providing the user with convenience and improving the comfort of mowing. Specifically, the upper lid of the front cover 23 may be movably or rotatably connected to the front cover 23 through a structure such as a slide rail or a hinge, which is not described in detail here. The upper lid of the front cover 23 may be provided according to a configuration of the storage space. The specific shape and size of the upper lid are not limited in the present application.

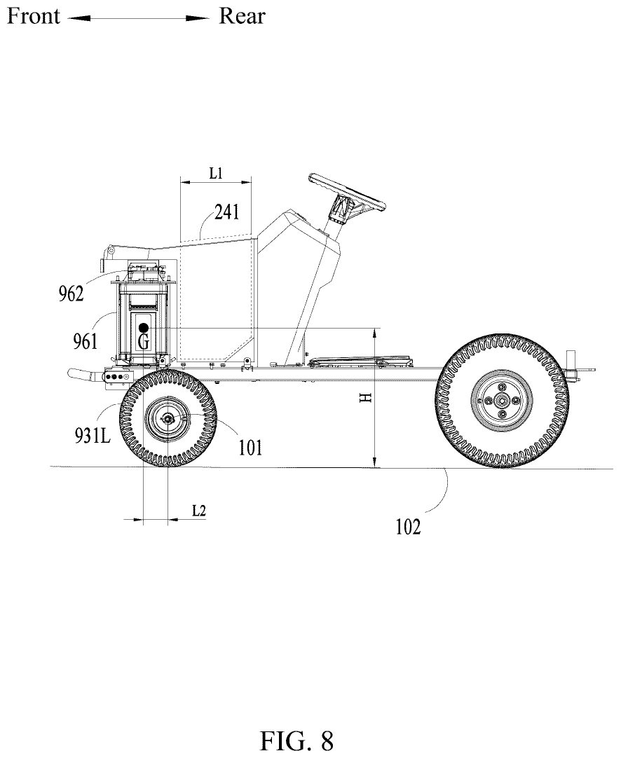

In some examples, as shown in FIG. 8, a maximum length L1 of the storage space 241 of the storage member 24 in the front and rear direction is greater than or equal to 150 mm and less than or equal to 300 mm. The maximum length L1 of the storage space 241 of the storage member 24 in the front and rear direction is greater than or equal to 200 mm and less than or equal to 270 mm. In some examples, the maximum length L1 is 160 mm, 180 mm, 220 mm, 240 mm, 260 mm, or 280 mm. It is to be noted that when the storage member 24 is formed with only one storage space 241, the maximum length L1 of the storage space 241 in the front and rear direction is determined to be a dimension of the storage space 241. When the storage member 24 is formed with multiple storage spaces 241, the maximum length L1 of the storage space 241 in the front and rear direction should be determined to be a sum of dimensions of all the storage spaces.

In some examples, the storage space 241 and the energy storage device 96 are separated from each other by a sidewall of the storage member 24. In this manner, the energy storage device 96 is free from pollution of an article in the storage member 24, and a natural barrier is formed by a structure of the storage member 24 to separate the storage space from the energy storage device so that a more compact space is formed, and the capacity of the storage space 241 can be increased. In the present application, the material of the storage member 24 is not limited. The material may be plastic, metal, a mixture of plastic and metal, or another material.

The energy storage device 96 is disposed on the front side of the seat 92 and configured to supply electric power to the cutting assembly 10, the walking assembly 93, and the lighting system 40. The first motor 13, the second motor 933, and the lighting system 40 are all electrical devices included in the manned mower 100 and these electrical devices can convert electrical energy into other forms of energy. The energy storage device 96 is disposed in the front portion of the manned mower 100 and is covered by the front cover 23. The front cover 23 is formed with the accommodation cavity 231 (as shown in FIG. 4) for accommodating at least the energy storage device 96. In the front and rear direction, the energy storage device 96 is disposed on the front side of the seat 92 and in a front portion of the accommodation cavity 231.

In some examples, the energy storage device 96 includes at least one battery pack 961 for storing electrical energy. Each of the at least one battery pack 961 includes multiple cells connected in series and/or in parallel. Each cell may be cylindrical, and the diameter of the cell is greater than or equal to 3 cm. For example, the diameter of the cell is 3 cm, 3.5 cm, or 4 cm. The height of the cell is greater than or equal to 8 cm. For example, the height of the cell is 8 cm, 9 cm, 10 cm, 11 cm, 12 cm, 13 cm, or 13.5 cm. In an example, the ratio of a cell length to the width of a battery pack 961 is greater than or equal to 0.7. In this example, the cells may be a lithium iron phosphate battery. Of course, the energy storage device 96 may be in another form, for example, a hydrogen fuel battery or a ternary lithium battery.

In some examples, the weight of the battery pack 961 is greater than or equal to 9 kg, for example, 9 kg, 10 kg, or 15 kg. The nominal voltage of the battery pack 961 is about 56 V, which may be, for example, 54 V or 58 V. The capacity of the battery pack 961 is greater than or equal to 20 Ah, which may be, for example, 20 Ah, 30 Ah, 40 Ah, or 50 Ah. The ratio of the capacity to the weight of the battery pack 961 is greater than or equal to 2 Ah/kg, for example, 2 Ah/kg, 4 Ah/kg, or 5 Ah/kg. The average discharge current of the battery pack 961 is greater than or equal to 30 A, which may be, for example, 30 A, 35 A, or 40 A. The energy of the battery pack 961 is greater than or equal to 2 kW·h, which may be, for example, 2 kW·h, 3 kW·h, 4 kW·h, or 5 kW·h. In an example, the battery pack 961 is basically rectangular, and the battery pack 961 has a height of about 330 mm, a length of about 320-330 mm, and a width of about 170-180 mm.

The energy storage device 96 further includes a battery management system (BMS). Specifically, the BMS is implemented by a battery management circuit board 962. The battery management circuit board 962 is mainly configured to manage charging and discharging processes of the at least one battery pack 961 and communication with a main control board of the manned mower 100. As shown in FIG. 8, the battery management circuit board 962 is disposed in the accommodation cavity 231 and above the at least one battery pack 961. The battery management circuit board 962 is relatively close to the at least one battery pack 961 so that a wiring path is relatively short, the front space of the whole machine can be effectively saved, and a large storage system is designed in the reserved space and may be used for carrying some garden tools and articles such as the crops and fertilizer. Moreover, a front portion of the front cover is provided with a vent. In this manner, when the manned mower 100 travels forward, the battery management circuit board 962 is blown against a wind, achieving a good heat dissipation effect.

In some examples, the energy storage device 96 is a built-in energy storage device undetachably mounted to the manned mower. The user charges the energy storage device 96 directly through a charging interface on the vehicle body and does not need to take out the energy storage device 96 and adapt the energy storage device 96 to a charger. In this manner, a complex connection structure is omitted, thereby saving the internal space.

As shown in FIG. 8, in the front and rear direction, the center of gravity G of the energy storage device 96 is located before a line 101 between the center point of the first left walking wheel 931L and the center point of the first right walking wheel 931R. FIG. 8 shows a projection of the line 101 in a left and right direction. In some examples, in the front and rear direction, the distance L2 between the center of gravity G of the energy storage device 96 and the line 101 is greater than or equal to 0 mm and less than or equal to 200 mm. In some examples, in the front and rear direction, the distance L2 between the center of gravity G of the energy storage device 96 and the line 101 is greater than or equal to 50 mm and less than or equal to 130 mm. In some examples, in the front and rear direction, the distance L2 between the center of gravity G of the energy storage device 96 and the line 101 may be 20 mm, 40 mm, 60 mm, 100 mm, 120 mm, 140 mm, 160 mm, or 180 mm. In this manner, the energy storage device 96 is placed forward, the center of gravity of the energy storage device 96 moves forward, and a relatively wide storage space is reserved in the front portion of the manned mower 100, making it convenient for the user to store small tools, gloves, sun protection hats, and even clothes and improving the comfort of the user during mowing. In another aspect, the center of gravity of the energy storage device 96 is moved forward so that the slope climbing capability of the manned mower can be improved, and the manned mower is more suitable for mowing or traveling under the working condition of a relatively large slope range. In addition, the center of gravity of the energy storage device 96 is moved forward so that the weight of a counterweight block of the whole machine can be reduced, and even the counterweight block can be removed. In this manner, the center of gravity of the whole machine is in a better state, and the weight of the whole machine is reduced.

In some examples, in an up and down direction, the distance H between the center of gravity of the energy storage device 96 and a walking plane 102 is greater than or equal to 380 mm and less than or equal to 520 mm. In some examples, in the up and down direction, the distance H between the center of gravity of the energy storage device 96 and the walking plane 102 is greater than or equal to 420 mm and less than or equal to 480 mm. In some examples, in the up and down direction, the distance H between the center of gravity of the energy storage device 96 and the walking plane 102 may be 440 mm, 450 mm, 460 mm, or 500 mm. The walking plane 102 may be understood as a ground plane that supports the walking wheels.

As shown in FIG. 1, the operating assembly 50 of the manned mower 100 includes a control panel 52, a steering wheel assembly 56, and a pedal assembly 59. In some examples, the pedal assembly 59 includes an accelerator pedal and a brake pedal. The control panel 52 and the steering wheel assembly 56 are disposed between the seat 92 and the front cover 23. In this example, the steering wheel assembly 56 includes a steering wheel 561 operable by the user to control a traveling direction of the manned mower 100. The control panel 52 is connected to the front cover 23. The control panel 52 includes a display screen and multiple operating members so that the user can conveniently see a display state on the display screen while operating the multiple operating members, which is more in line with the ergonomic design. The display screen is used for displaying state information of the manned mower 100. The multiple operating members are operable by the user to control the walking assembly and the cutting assembly and may include a switch, a key, or a gear. The multiple operating members may be configured to be in different shapes and of different sizes so that the user can operate different operating members without viewing the operating members.

Currently available riding mowers and garden tractors are allowed to use tools installed on a front or rear portion of a lawn maintenance vehicle. When such tools are used, the tools are attached by using screw fasteners or a separate manual tool in many known fastening methods. The connection of the tools to the lawn maintenance vehicle may require additional time and effort. The tools mainly include, but are not limited to, a spade, a hammer, a screwdriver, a ratchet kit, a wrench, and other manual tools.

As shown in FIG. 1, the manned mower 100 further includes a tool attachment device 97. The tool attachment device 97 in the present application may be described as a “quick attachment device” because the tool attachment device can implement tool attachment without mating with a fastener or the like. Examples of the manned mower 100 include, but are not limited to, a stand-on mower, a lawn tractor, and other utility vehicles such as an all-terrain vehicle. In addition, a trailing hook 97a connected to the frame 91 is further disposed near the tool attachment device 97 of the manned mower 100. When the manned mower 100 fails or cannot walk normally due to a power shortage, the user can connect another apparatus to the trailing hook 97a to trail the manned mower that cannot travel normally back to a charging station or an after-sales maintenance department. Of course, the trailing hook 97a may also have another use, for example, the manned mower 100 transports some other apparatuses through the trailing hook 97a.

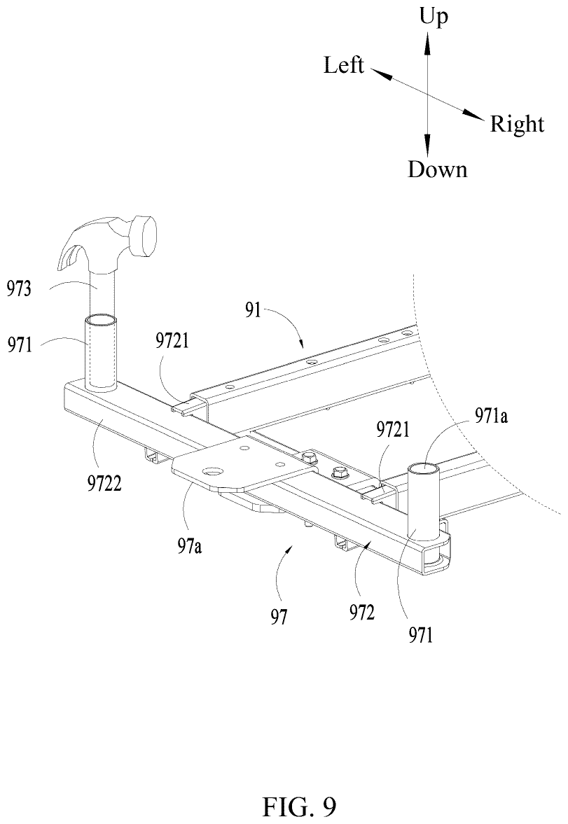

As shown in FIG. 9, the tool attachment device 97 is mounted to the frame 91 and disposed behind the seat 92. Of course, the tool attachment device 97 may be mounted at another position of the manned mower 100, for example, on the front side, left side, or right side of the manned mower. It is to be noted that the seat may be understood as a support member. In other machines such as the stand-on mower, the support member is a stand for supporting an operator. In some examples, the tool attachment device 97 includes at least one attachment member 971, and the at least one attachment member 971 allows a tool 973 to be inserted substantially along the up and down direction. In some examples, the attachment member 971 includes a tubular member, the tubular member includes an accommodation cavity 971a that can accommodate at least part of the tool 973, and the accommodation cavity 971a extends substantially along the up and down direction. The attachment member 971 includes a hollow tubular member, and the tool 973 can adapt to a hollow area of the tubular member to be limited in the tubular member. In some examples, the tool attachment device 97 includes at least two attachment members 971, and each attachment member 971 can independently adapt to the tool. In some examples, three, four, or more attachment members 971 may be provided. The attachment member 971 may be in the shape of a circular tube or a square tube. In some examples, the attachment member 971 is made of metal, thereby ensuring that no deformation occurs when the tool is placed. In some examples, the tool 973 includes a rod-like tool such as a spade or a hammer.

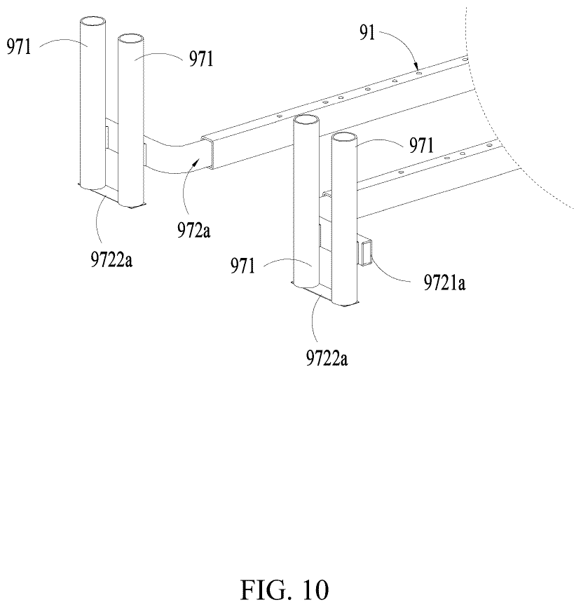

The tool attachment device 97 further includes a connector, and the connector 972 is fixedly mounted to the frame 91 or integrally formed with the frame 91. In some examples, the connector 972 includes limiting members 9721 fixedly connected to the frame 91 and a fixing member 9722 extending along the left and right direction. The attachment member 971 is mounted to the fixing member 9722. In some examples, the fixing member 9722 is detachably mounted to the limiting members 9721 so that the user can flexibly choose to detach the fixing member and the attachment member mounted on the fixing member when no tool needs to be carried. Of course, the user may select, according to the tool 973 that needs to be carried, an appropriate attachment member 971 that adapts to the tool 973. Of course, the connector may be in another form. As shown in FIG. 10, a connector 972a includes an L-shaped rectangular tube 9721a. The rectangular tube 9721a is fixed to the frame 91, and the attachment member 971 is fixed to the rectangular tube 9721a. In some examples, the connector 972a further includes a base plate 9722a disposed at the bottom of the attachment member 971 and configured to support the attachment member 971.

The tool attachment device 97 in the present application can provide a convenient, fast, and cheap manner for connecting the tool to the manned mower without using a separate manual tool such as a screwdriver, a ratchet kit, or a wrench. Compared with other attachment methods and structures, the described structure can provide a relatively secure connection between the tool and the lawn maintenance vehicle.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A manned mower, comprising:
a seat;
a frame for supporting the seat;
a cutting assembly mounted on the frame and comprising a mowing element for cutting grass;
a walking assembly mounted on the frame and comprising a front walking assembly, wherein the front walking assembly comprises a left walking wheel and a right walking wheel;
an energy storage device disposed on a front side of the seat and configured to supply power to the cutting assembly and the walking assembly; and
a front cover disposed on a front portion of the manned mower having an accommodation cavity for accommodating at least the energy storage device;
wherein in a front and rear direction, a center of gravity of the energy storage device is located before a line connecting a center point of the left walking wheel and a center point of the right walking wheel.

2. The manned mower of claim 1, wherein the energy storage device is undetachably mounted on the manned mower.

3. The manned mower of claim 1, wherein in an up and down direction, a distance H between the center of gravity of the energy storage device and a walking plane is greater than or equal to 380 mm and less than or equal to 520 mm.

4. The manned mower of claim 1, wherein in the front and rear direction, a distance L2 between the center of gravity of the energy storage device and the line is greater than 0 mm and less than or equal to 200 mm.

5. The manned mower of claim 1, wherein in the front and rear direction, the energy storage device is disposed on the front side of the seat and in a front portion of the accommodation cavity.

6. The manned mower of claim 1, wherein the energy storage device comprises at least one battery pack, and the energy of each of the at least one battery pack is greater than or equal to 2 kW·h.

7. The manned mower of claim 6, wherein the at least one battery pack is at least one of a lithium iron phosphate battery, a hydrogen fuel battery, or a ternary lithium battery.

8. The manned mower of claim 6, wherein a ratio of a cell length of the at least one battery pack to a width of the at least one battery pack is greater than or equal to 0.7.

9. The manned mower of claim 6, wherein a ratio of a capacity of the each of the at least one battery pack to a weight of the each of the at least one battery pack is greater than or equal to 2 Ah/kg.

10. The manned mower of claim 6, wherein the energy storage device further comprises a battery management circuit board disposed in the accommodation cavity and above the at least one battery pack.

11. The manned mower of claim 10, wherein a front portion of the front cover is provided with a vent, and an airflow that enters from the vent is blown to the battery management circuit board when the manned mower travels forward.

12. The manned mower of claim 1, further comprising a storage member, wherein at least part of the storage member is movably connected to the front cover.

13. The manned mower of claim 12, wherein the storage member is formed with a storage space opened upward, and the storage space is separated from the energy storage device by the storage member.

14. The manned mower of claim 13, wherein the storage space is located behind the energy storage device in the front and rear direction.

15. The manned mower of claim 13, wherein the front cover comprises an upper lid, the upper lid has an opened position and a closed position, and the storage space is touchable by a user when the upper lid is at the opened position.

16. The manned mower of claim 12, wherein a maximum length L1 of a storage space of the storage member in the front and rear direction is greater than or equal to 150 mm and less than or equal to 300 mm.

17. The manned mower of claim 12, wherein the storage member is a flip storage box, an end of the storage member is rotatably mounted to the front cover, the storage member is flipped relative to the front cover so that an opening direction of the storage space is changed.

18. The manned mower of claim 1, further comprising a storage member, wherein the storage member is detachably connected to the front cover.

19. The manned mower of claim 1, wherein in the front and rear direction, a distance L2 between the center of gravity of the energy storage device and the line is greater than or equal to 50 mm and less than or equal to 130 mm.
